(19) United States
(12) Patent Application Publication
(10) Pub. No.: US 2019/0310713 A1
(43) Pub. Date: Oct. 10, 2019

(54) Sensors for Electronic Finger Devices

(71) Applicant: Apple Inc., Cupertino, CA (US)

(72) Inventors: Paul X. Wang, San Jose, CA (US); Alex J. Lehmann, Sunnyvale, CA (US); Tianjia Sun, Santa Clara, CA (US); Yoonhoo Jo, San Francisco, CA (US); Hongcheng Sun, San Ramon, CA (US)

(21) Appl. No.: 16/136,132

(22) Filed: Sep. 19, 2018

Related U.S. Application Data
(60) Provisional application No. 62/655,050, filed on Apr. 9, 2018.
(60) Provisional application No. 62/680,495, filed on Jun. 4, 2018.

(51) Int. Cl. G06F 3/01; G06F 3/038

(52) U.S. Cl. CPC G06F 3/017; G06F 3/016; G06F 3/0383; G06F 3/014

(57) ABSTRACT

A system may include one or more finger-mounted devices such as finger devices with U-shaped housings configured to be mounted on a user's fingers while gathering sensor input and supplying haptic output. The sensors may include strain gauge circuitry mounted on elongated arms of the housing. When the arms move due to finger forces, the strain gauge circuitry can measure the arm movement. The sensors may also include ultrasonic sensors. An ultrasonic sensor may have an ultrasonic signal emitter and a corresponding ultrasonic signal detector configured to detect the ultrasonic signals after passing through a user's finger. A two-dimensional ultrasonic sensor may capture ultrasonic images of a user's finger pad. Ultrasonic proximity sensors may be used to measure distances between finger devices and external surfaces. Optical sensors and other sensors may also be used in the finger devices.

This application claims priority to U.S. provisional patent application No. 62/680,495 filed Jun. 4, 2018, and provisional patent application No. 62/655,050 filed Apr. 9, 2018, which are hereby incorporated by reference herein in its entireties.

### FIELD

This relates generally to electronic devices, and, more particularly, to sensors for finger-mounted electronic devices.

### BACKGROUND

Electronic devices such as computers can be controlled using computer mice and other input accessories. In virtual reality systems, force-feedback gloves can be used to control virtual objects. Cellular telephones may have touch screen displays and vibrators that are used to create haptic feedback in response to touch input.

Devices such as these may not be convenient for a user. For example, computer mice generally require flat surfaces for operation and are mostly used with desktop computers in fixed locations. Force-feedback gloves can be cumbersome and uncomfortable. Touch screen displays with haptic feedback only provide haptic output when a user is interacting with the displays.

### SUMMARY

A system may include one or more finger-mounted devices such as finger devices with U-shaped housings configured to be mounted on a user's fingers while gathering sensor input and supplying haptic output. The sensors may include strain gauge circuitry mounted on elongated arms of the housing. When the arms move due to finger forces, the strain gauge circuitry can measure the arm movement. This allows control circuitry in a finger device to gather information on finger motion and orientation relative to external structures. For example, information can be gathered on whether a user's finger has touched an external surface, information on shear forces imposed as a user's finger drags along a surface, information on the distance separating a finger from a surface, and other finger information.

In some arrangements a finger device may include ultrasonic sensors. An ultrasonic sensor may have an ultrasonic signal emitter and a corresponding ultrasonic signal detector configured to detect the ultrasonic signals after passing through a user's finger. A two-dimensional ultrasonic sensor may capture ultrasonic images of a user's finger pad. Ultrasonic proximity sensors may be used to measure distances between finger devices and external surfaces. Optical sensors and other sensors may also be used in the finger devices.

Finger input gathered using one or more finger devices may be provided to ancillary equipment such as electronic equipment with a display and may be used in controlling the operation of the electronic equipment.

### BRIEF DESCRIPTION OF THE DRAWINGS

FIG. 1 is a schematic diagram of an illustrative system with a finger device in accordance with an embodiment.

FIG. 2 is a top view of an illustrative finger of a user on which a finger device has been placed in accordance with an embodiment.

FIG. 3 is a cross-sectional side view of an illustrative finger device on the finger of a user in accordance with an embodiment.

FIG. 4 is a perspective view of an illustrative finger device in accordance with an embodiment.

FIG. 5 is a cross-sectional view of a portion of the illustrative finger device of FIG. 4 showing how the finger device may have curved elongated arms that extend around a lower part of a finger pad of a finger in accordance with an embodiment.

FIG. 6 is a perspective view of an illustrative finger device with vertical slits that form vertically extending arms in accordance with an embodiment.

FIG. 7 is a cross-sectional side view of an illustrative finger device with recesses and sensors in the recesses in accordance with an embodiment.

FIG. 8 is an end view of an illustrative finger device with curved sides mounted on a finger in accordance with an embodiment.

FIG. 9 is a front view of an illustrative finger device with a flexible housing member formed from an elastomeric member coupled to a main portion of a finger device housing in accordance with an embodiment.

FIG. 10 is a perspective view of the illustrative finger device of FIG. 9 in accordance with an embodiment.

FIG. 11 is a bottom view of the illustrative finger device of FIG. 9 in accordance with an embodiment.

FIG. 12 is a front view of an illustrative finger device having an ultrasonic sensor with an ultrasonic signal emitting device such as a vibrating actuator and an ultrasonic signal detecting device in accordance with an embodiment.

FIG. 13 is a graph in which an illustrative output of an actuator and corresponding sensed signal from a sensor in a finger device have been plotted as a function of time.

FIG. 14 is a front view of an illustrative finger device with a downwardly directed ultrasonic sensor that is angled perpendicularly to a longitudinal axis of the finger device in accordance with an embodiment.

FIG. 15 is a side view of an illustrative finger device with a forwardly directed ultrasonic sensor mounted in a housing extension and configured to emit ultrasonic signals in a direction parallel to a longitudinal axis of the finger device in accordance with an embodiment.

FIG. 16 is a side view of an illustrative finger device with a forwardly directed ultrasonic sensor mounted on an upper housing wall portion of the finger device in accordance with an embodiment.

FIG. 17 is a front view of a pair of finger devices with interacting components such as ultrasonic signal emitters and detectors in accordance with an embodiment.

FIG. 18 is a perspective view of an illustrative two-dimensional ultrasonic sensor array for a two-dimensional ultrasonic imaging sensor in accordance with an embodiment.

FIG. 19 is a front view of an illustrative finger device that includes a two-dimensional ultrasonic sensor in accordance with an embodiment.

FIG. 20 is a front view of an illustrative finger device with optical sensors in accordance with an embodiment.

FIG. 21 is a perspective view of an illustrative finger device having a curved trailing edge and tapered curved arms in accordance with an embodiment.

FIG. 22 is a side view of an illustrative finger device with a curved trailing edge during use on a bent finger in accordance with an embodiment.

### DETAILED DESCRIPTION

Electronic devices that are configured to be mounted on the body of a user may be used to gather user input and to provide a user with output. For example, electronic devices that are configured to be worn on one or more of a user's fingers, which are sometimes referred to as finger devices or finger-mounted devices, may be used to gather user input and to supply output. A finger device may, as an example, include an inertial measurement unit with an accelerometer for gathering information on figure motions such as finger taps or free-space finger gestures, may include force sensors for gathering information on normal and shear forces in the finger device and the user's finger, and may include other sensors for gathering information on the interactions between the finger device (and the user's finger on which the device is mounted) and the surrounding environment. The finger device may include a haptic output device to provide the user's finger with haptic output and may include other output components.

One or more finger devices may gather user input from a user. The user may use finger devices in operating a virtual reality or mixed reality device (e.g., head-mounted equipment such as glasses, goggles, a helmet, or other device with a display). During operation, the finger devices may gather user input such as information on interactions between the finger device(s) and the surrounding environment (e.g., interactions between a user's fingers and the environment, including finger motions and other interactions associated with virtual content displayed for a user). The user input may be used in controlling visual output on the display. Corresponding haptic output may be provided to the user's fingers using the finger devices. Haptic output may be used, for example, to provide the fingers of a user with a desired texture sensation as a user is touching a real object or as a user is touching a virtual object.

Finger devices can be worn on any or all of a user's fingers (e.g., the index finger, the index finger and thumb, three of a user's fingers on one of the user's hands, some or all fingers on both hands, etc.). To enhance the sensitivity of a user's touch as the user interacts with surrounding objects, finger devices may have inverted U shapes or other configurations that allow the finger devices to be worn over the top and sides of a user's finger tips while leaving the user's finger pads exposed. This allows a user to touch objects with the finger pad portions of the user's fingers during use. Users can use the finger devices to interact with any suitable electronic equipment. For example, a user may use one or more finger devices to interact with a virtual reality or mixed reality system (e.g., a head-mounted device with a display), to supply input to a desktop computer, tablet computer, cellular telephone, watch, ear buds, or other accessory, or to interact with other electronic equipment.

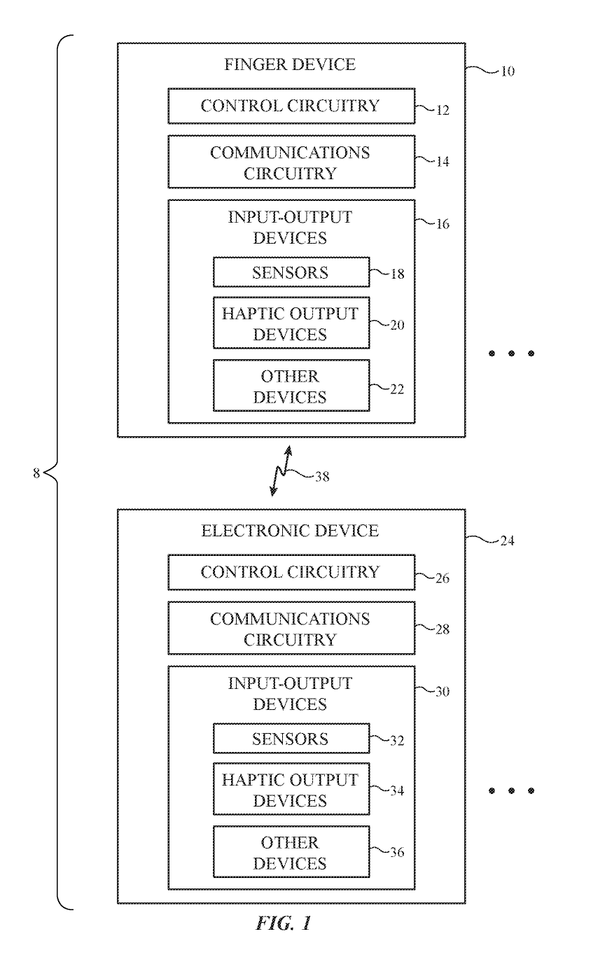

FIG. 1 is a schematic diagram of an illustrative system of the type that may include one or more finger devices. As shown in FIG. 1, system 8 may include electronic device(s) such as finger device(s) 10 and other electronic device(s) 24. Each finger device 10 may be worn on a finger of a user's hand. Additional electronic devices in system 8 such as devices 24 may include devices such as a laptop computer, a computer monitor containing an embedded computer, a tablet computer, a desktop computer, a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a remote control, a navigation device, an embedded system such as a system in which equipment is mounted in a kiosk, in an automobile, airplane, or other vehicle, a removable external case for electronic equipment, a strap, a wrist band or head band, a removable cover for a device, a case or bag that has straps or that has other structures to receive and carry electronic equipment and other items, a necklace or arm band, a wallet, sleeve, pocket, or other structure into which electronic equipment or other items may be inserted, part of a chair, sofa, or other seating (e.g., cushions or other seating structures), part of an item of clothing or other wearable item (e.g., a hat, belt, wrist band, headband, sock, glove, shirt, pants, etc.), or equipment that implements the functionality of two or more of these devices.

With one illustrative configuration, which may sometimes be described herein as an example, device 10 is a finger-mounted device having a finger-mounted housing with a U-shaped body that grasps a user's finger or a finger-mounted housing with other shapes configured to rest against a user's finger and device(s) 24 is a cellular telephone, tablet computer, laptop computer, wristwatch device, head-mounted device, a device with a speaker, or other electronic device (e.g., a device with a display, audio components, and/or other output components).

Devices 10 and 24 may include control circuitry 12 and 26. Control circuitry 12 and 26 may include storage and processing circuitry for supporting the operation of system 8. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 12 and 26 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc.

To support communications between devices 10 and 24 and/or to support communications between equipment in system 8 and external electronic equipment, control circuitry 12 may communicate using communications circuitry 14 and/or control circuitry 26 may communicate using communications circuitry 28. Circuitry 14 and/or 28 may include antennas, radio-frequency transceiver circuitry, and other wireless communications circuitry and/or wired communications circuitry. Circuitry 14 and/or 26, which may sometimes be referred to as control circuitry and/or control and communications circuitry, may, for example, support bidirectional wireless communications between devices 10 and 24 over wireless link 38 (e.g., a wireless local area network link, a near-field communications link, or other suitable wired or wireless communications link (e.g., a Bluetooth® link, a WiFi® link, a 60 GHz link or other millimeter wave link, etc.). Devices 10 and 24 may also include power circuits for transmitting and/or receiving wired and/or wireless power and may include batteries. In configurations in which wireless power transfer is supported between devices 10 and 24, in-band wireless communications may be supported using inductive power transfer coils (as an example).

Devices 10 and 24 may include input-output devices such as devices 16 and 30. Input-output devices 16 and/or 30 may be used in gathering user input, in gathering information on the environment surrounding the user, and/or in providing a user with output. Devices 16 may include sensors 18 and devices 24 may include sensors 32. Sensors 18 and/or 32 may include force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or inertial measurement units that contain some or all of these sensors), muscle activity sensors (EMG) for detecting finger actions, radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, and/or other sensors. In some arrangements, devices 10 and/or 24 may use sensors 18 and/or 32 and/or other input-output devices 16 and/or 30 to gather user input (e.g., buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.).

Devices 16 and/or 30 may include haptic output devices 20 and/or 34. Haptic output devices 20 and/or 34 can produce motion that is sensed by the user (e.g., through the user's fingertips). Haptic output devices 20 and/or 34 may include actuators such as electromagnetic actuators, motors, piezoelectric actuators, electroactive polymer actuators, vibrators, linear actuators, rotational actuators, actuators that bend bendable members, actuator devices that create and/or control repulsive and/or attractive forces between devices 10 and/or 24 (e.g., components for creating electrostatic repulsion and/or attraction such as electrodes, components for producing ultrasonic output such as ultrasonic transducers, components for producing magnetic interactions such as electromagnets for producing direct-current and/or alternating-current magnetic fields, permanent magnets, magnetic materials such as iron or ferrite, and/or other circuitry for producing repulsive and/or attractive forces between devices 10 and/or 24). In some situations, actuators for creating forces in device 10 may be used in squeezing a user's finger and/or otherwise directly interacting with a user's finger pulp. In other situations, these components may be used to interact with each other (e.g., by creating a dynamically adjustable electromagnetic repulsion and/or attraction force between a pair of devices 10 and/or between device(s) 10 and device(s) 24 using electromagnets).

If desired, input-output devices 16 and/or 30 may include other devices 22 and/or 36 such as displays (e.g., in device 24 to display images for a user), status indicator lights (e.g., a light-emitting diode in device 10 and/or 24 that serves as a power indicator, and other light-based output devices), speakers and other audio output devices, electromagnets, permanent magnets, structures formed from magnetic material (e.g., iron bars or other ferromagnetic members that are attracted to magnets such as electromagnets and/or permanent magnets), batteries, etc. Devices 10 and/or 24 may also include power transmitting and/or receiving circuits configured to transmit and/or receive wired and/or wireless power signals.

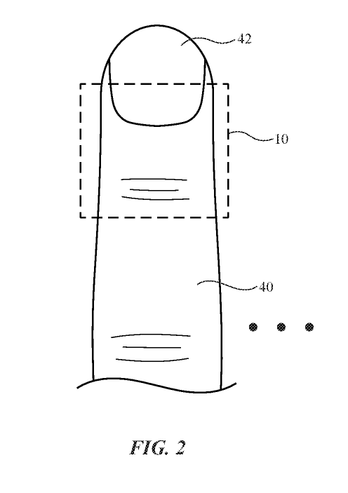

FIG. 2 is a top view of a user's finger (finger 40) and an illustrative finger-mounted device 10. As shown in FIG. 2, device 10 may be formed from a finger-mounted unit that is mounted on or near the tip of finger 40 (e.g., partly or completely overlapping fingernail 42). If desired, device 10 may be worn elsewhere on a user's fingers.

A user may wear one or more of devices 10 simultaneously. For example, a user may wear a single one of devices 10 on the user's ring finger or index finger. As another example, a user may wear a first device 10 on the user's thumb, a second device 10 on the user's index finger, and an optional third device 10 on the user's middle finger. Arrangements in which devices 10 are worn on other fingers and/or all fingers of one or both hands of a user may also be used.

Control circuitry 12 (and, if desired, communications circuitry 14 and/or input-output devices 16) may be contained entirely within device 10 (e.g., in a housing for a fingertip-mounted unit) and/or may include circuitry that is coupled to a fingertip structure (e.g., by wires from an associated wrist band, glove, fingerless glove, etc.). Configurations in which devices 10 have bodies that are mounted on individual user fingertips are sometimes described herein as an example.

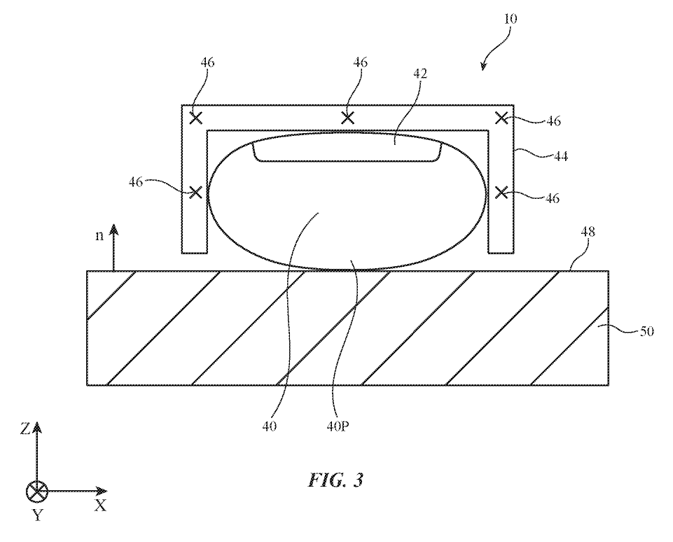

FIG. 3 is a cross-sectional side view of an illustrative finger device (finger-mounted device) 10 showing illustrative mounting locations 46 for electrical components (e.g., control circuitry 12, communications circuitry 14, and/or input-output devices 16) within and/or on the surface(s) of finger device housing 44. These components may, if desired, be incorporated into other portions of housing 44.

As shown in FIG. 3, housing 44 may have a U shape (e.g., housing 44 may be a U-shaped housing structure that faces downwardly and covers the tip of user finger 40 and fingernail 42). During operation, a user may press against structures such as structure 50. As the bottom of finger 40 (e.g., finger pulp 40P) presses against surface 48 of structure 50, the user's finger may compress and force portions of the finger outwardly against the sidewall portions of housing 44 (e.g., for sensing by force sensors or other sensors mounted to the side portions of housing 44). Lateral movement of finger 40 in the X-Y plane may also be sensed using force sensors or other sensors on the sidewalls of housing 44 or other portions of housing 44 (e.g., because lateral movement will tend to press portions of finger 40 against some sensors more than others and/or will create shear forces that are measured by force sensors that are configured to sense shear forces). Ultrasonic sensors, optical sensors, inertial measurement units, and/or other sensors may be used in gathering sensor measurements indicative of the activities of finger 40.

The sensors in device 10 can measure how forcefully a user is moving device 10 (and finger 40) against surface 48 (e.g., in a direction parallel to the surface normal n of surface 48 such as the -Z direction of FIG. 3) and/or how forcefully a user is moving device 10 (and finger 40) within the X-Y plane, tangential to surface 48. The direction of movement of device 10 in the X-Y plane and/or in the Z direction can also be measured by the force sensors and/or other sensors 18 at locations 46.

Structure 50 may be a portion of a housing of device 24, may be a portion of another device 10 (e.g., another housing 44), may be a portion of a user's finger 40 or other body part, may be a surface of a real-world object such as a table, a movable real-world object such as a bottle or pen, or other inanimate object external to device 10, and/or may be any other structure that the user can contact with finger 40 while moving finger 40 in a desired direction with a desired force. Because motions such as these can be sensed by device 10, device(s) 10 can be used to gather pointing input (e.g., input moving a cursor or other virtual object on a display such as a display in devices 36), can be used to gather tap input, swipe input, pinch-to-zoom input (e.g., when a pair of devices 10 is used), or other gesture input (e.g., finger gestures, hand gestures, arm motions, etc.), and/or other user input.

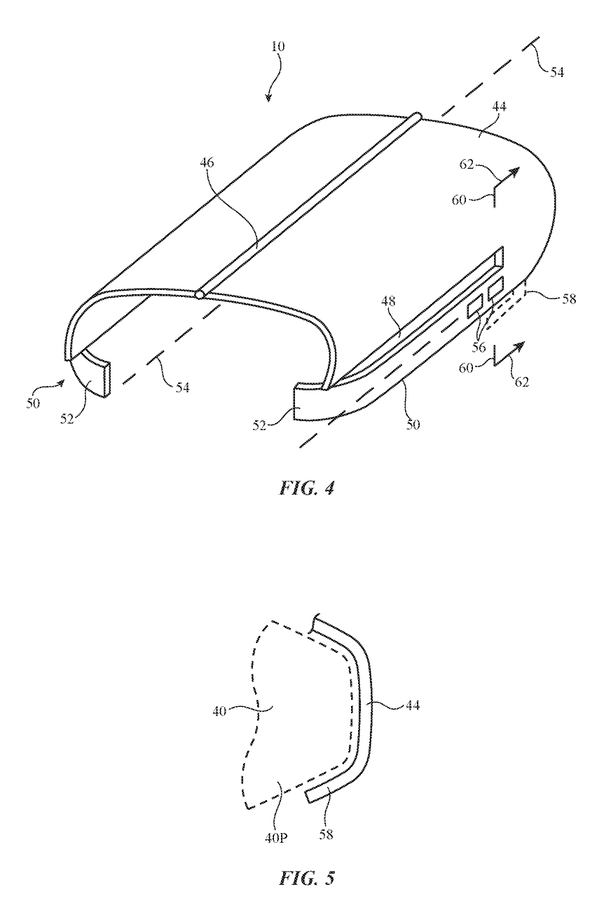

FIG. 4 is a perspective view of an illustrative finger device. In the illustrative configuration of FIG. 4, housing 44 of finger device 10 has portions 52 and/or 58 with shapes that help hold finger device 10 securely on finger 40. Portions 52 and/or 58, which may sometimes be referred to as bent or curved arms, bent or curved protruding portions, angled housing structures, etc. may have curved cross-sectional profiles that allow these portions to conform to the curved outer surface of finger 40 and thereby rest against these surfaces while holding housing 44 in place on finger 40. Portions 52 may, for example, be configured to curve around the tip of the user's finger on the left and right of finger 40. Portions 58 may be configured to curve around left and right edge portions of the lower surface of the user's finger pad. Additional arms and/or other structures in housing 44 that help securely mount device 10 on finger 40 may be used, if desired.

Portions 52 may, if desired, each be separated from remaining portions of housing 44 by a horizontal slot 48. Portions 52 may have elongated shaped that extend horizontally parallel to longitudinal finger device axis 54. Slots 48 may also extend along axis 54. Due to the presence of slot 48, each portion 52 may bend laterally (e.g., when pressed sideways by finger 40).

Strain gauges or other sensors may be used in measuring the bending of portion 52. For example, a pair of strain gauges 56 may be placed on an area of portion 52 near to the base of slot 48 as shown in FIG. 4. In this location, bending forces from the bending of portion 52 are concentrated and can be measured effectively using strain gauges 56. When strain gauges 56 are coupled to portion 52 at different locations along the length of portion 52 (e.g. at different respective positions along axis 54), each strain gauge will measure a different amount of force. For example, a first of strain gauges 56 may produce an output F1 and a second of strain gauges 56 may produce an output F2. Noise (e.g., spurious signals due to heat and/or other noise sources) can be reduced in the strain gauge measurements made using strain gauges 56 by processing both of signals F1 and F2 (e.g., by computing a ratio of F1 and F2, etc.). In situations in which an output is produced in response to bending of portion 52, signals F1 and F2 will tend to be correlated, whereas in situations in which an output signal is due to noise, signals F1 and F2 will be uncorrelated. Strain gauges 56 may be formed from meandering traces that serve as strain-dependent-variable resistors. The traces may extend along axis 54 (e.g., perpendicular to the bend axis of portion 52) to help enhance the magnitude of the output signals from the strain gauge circuitry.

As shown in FIG. 4, device 10 may, if desired, have an optional hinge such as hinge 46. Hinge 46 may allow the left and right sides of housing 44 to be moved towards or away from each other to accommodate fingers of different sizes.

FIG. 5 is a cross-sectional side view of housing 44 taken along lines 60 and viewed in direction 62. As shown in FIG. 5, downwardly protruding portion 58 may have a curved cross-sectional profile that is configured to fit under finger pad 40P of finger 40 and thereby help snuggly fit housing 44 to the surface of the user's finger and retain housing 44 on finger 40 during use. If desired, strain gauge circuitry may be formed on elongated portions of housing 44 such as portions 58 in addition to or instead of forming the strain gauge circuitry on elongated portions 52.

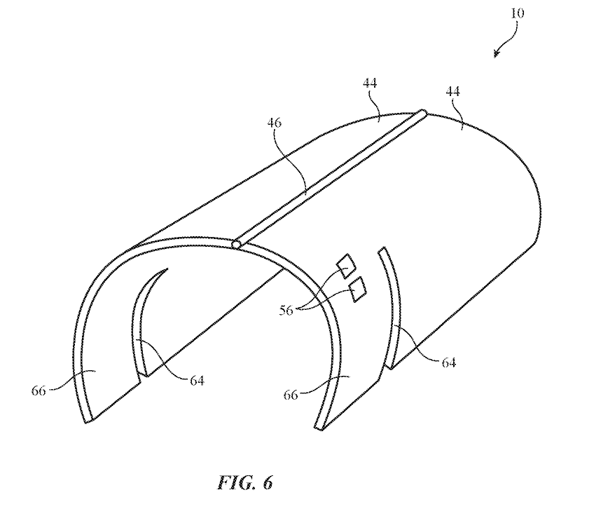

FIG. 6 is a perspective view of device 10 in an illustrative configuration in which housing 44 has been provided with a vertical slot such as slot 64. Each side of housing 44 (e.g., the housing on the left and right sides of finger 40) may have a respective vertical slot 64. The presence of vertical slots 64 may allow vertical arms such as vertical elongated housing portions 66 to bend as finger 40 is moved. Strain gauges 56 may be mounted to the bases of these arms (as an example).

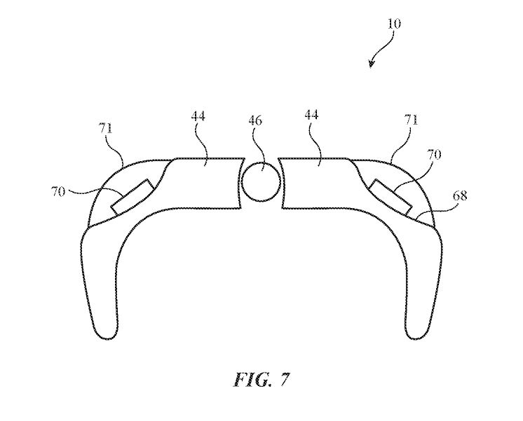

FIG. 7 is a cross-sectional front view of device 10 in an illustrative arrangement in which housing 44 has recesses forming recessed surfaces 68. Components 70 (e.g., strain gauges, other input-output devices 16, control circuitry 12, communications circuitry 14, and/or other circuitry) can be mounted to surfaces 68 and covered with polymer 71 or other covering structures.

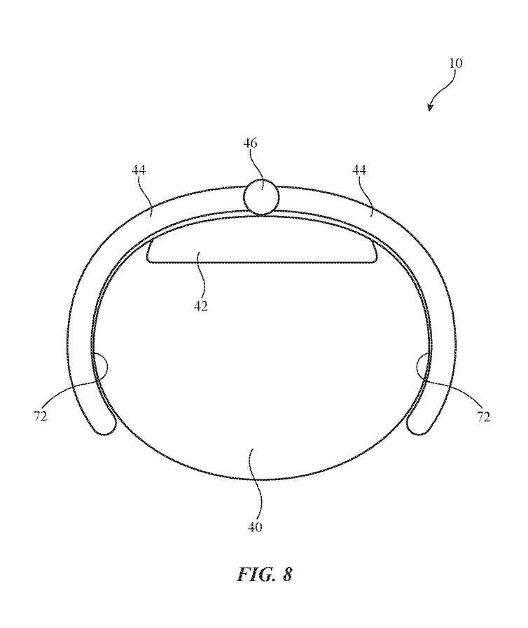

As shown in the cross-sectional front view of device 10 of FIG. 8, housing 44 can be configured to have curved cross-sectional profiles and curved inner surfaces 72 that match the opposing curved outer surfaces of finger 40. The extended (and, if desired, thinned) curved tips of the portions of housing 44 that extend along the sides of finger 40 and under parts of the lower surfaces of finger 40 may be sufficiently flexible to bend during use, so that strain gauges on housing 44 can detect finger movement.

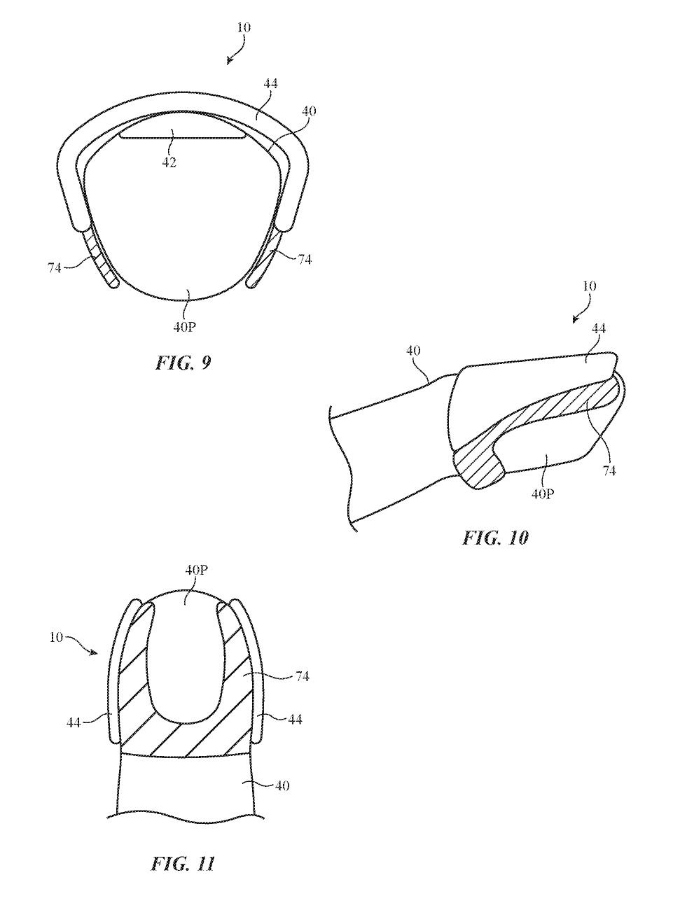

FIG. 9 is a cross-sectional front view of device 10 showing how device 10 may have a housing formed from multiple materials. The main portion of housing 44 may be formed, for example, from a durable polymer. A cosmetic covering may, if desired, be placed over housing 44. Elastomeric structures such as elastomeric portions 74 of housing 44 may be formed from a soft pliable substance such as silicone. The elastic modulus of the main housing portion (e.g., the Young's modulus of the main portion of housing 44) may be, for example, at least 0.5 GPa, whereas the elastic modulus for elastomeric portion 74 may be, for example, less than 0.1 GPa. The presence of elastomeric structures such as elastomeric housing portion 74 (which may be sometimes be referred to as an elastomeric sleeve, elastomeric wall structure, or elastomeric housing member) may help device 10 conform to finger 40 and grip finger 40 during use. FIG. 10 is a perspective side view of an illustrative finger device showing how some of the lower surface of the user's finger pad 40P and the front tip of finger 40 may be left exposed (e.g., elastomeric housing portion 74 may extend only around the edges of finger 40). FIG. 11 is a lower view of an illustrative finger device and finger 40 showing how portion 74 may be formed as a single continuous pliable member (e.g., an elastomeric polymer or other material that stretches more readily than the durable plastic and/or other materials forming the remainder of housing 44).

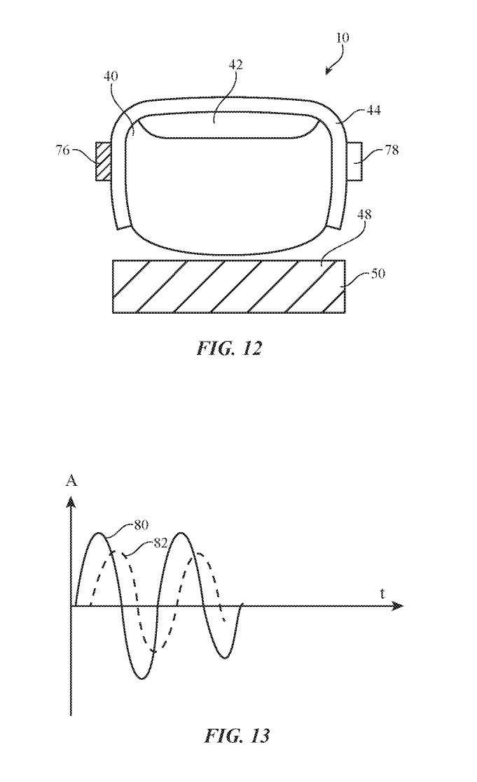

FIG. 12 is a front view of device 10 in an illustrative configuration in which the movement of finger 40 is tracked using sensor circuitry that emits and detect vibrations (e.g., an ultrasonic sensor that emits and detects ultrasonic vibrations). The sensor of FIG. 12 emits vibrations with a piezoelectric device or other transducer that generates movement in response to an electrical input signal while simultaneously measuring the vibrations after the vibrations have passed through finger 40 and have been modified (e.g., damped) by the effects of propagating through finger 40. With one illustrative arrangement, signals handled by the ultrasonic sensor of device 10 have frequencies of at least 40 kHz, at least 100 kHz, at least 200 kHz, at least 1 MHz, less than 2 MHz, less than 800 kHz, less than 500 kHz, or other suitable frequencies. Configurations in which this sensor handles sub-ultrasonic frequencies (e.g., 10 kHz) may also be used, if desired.

As shown in the example of FIG. 12, the ultrasonic sensor circuitry of device 10 may include a first device such as device 76 that is mounted on a first side portion of housing 44 and a second device such as device 78 that is mounted on an opposing second side portion of housing 44. In this arrangement, finger 40 will lie between devices 76 and 78 during operation. Device 76 may be a piezoelectric transducer or other ultrasonic signal emitting device that creates vibrating output in response to electrical control signals from control circuitry 14. Device 78 may be an ultrasonic signal measurement device such as a transducer that converts ultrasonic vibrations into electrical signals such as a vibration sensor (e.g., a strain gauge, a piezoelectric sensor, or other force sensor). During operation, device 76 may emit signals such as signals 80 of amplitude A in the graph of FIG. 13. The phase and magnitude of these signals will be altered by propagation through finger 40 and can be detected as measured signals 82 by device 78. The measured characteristics of signal 82 (e.g., magnitude, phase, etc.) will tend to vary as finger 40 is pressed against surface 48 of structure 50 and finger pulp 40P is compressed. In this way, devices 76 and 78 may be used by control circuitry 12 to determine whether finger 40 is in free space or is contacting an external object and can determine how forcefully an external object is being pressed.

In the example of FIG. 14, the movement of finger 40 is being tracked using an ultrasonic sensor that may serve as a proximity sensor. Ultrasonic sensor 84 of FIG. 14 emits ultrasonic signals (e.g., ultrasonic acoustic waves that travel through air). Sensor 84 also has a microphone or other ultrasonic sound detector that detects emitted ultrasonic signals after these signals have reflected from external objects. Time-of-flight measurements, ultrasonic sound magnitude and phase measurements, and/or other ultrasonic signal measurements can be made by control circuitry 12 to monitor finger activity. For example, ultrasonic sensor 84 can be used to emit signals that are reflected from surface 48 of structure 50 and detected by sensor 84 (e.g., a microphone or other sound sensor in sensor 84). The strength and/or other attributes of the reflected signals can be measured to determine whether finger 40 is in proximity to surface 48, whether finger 40 is moving towards or away from surface 48 (and how rapidly), and/or whether finger 40 has contacted surface 48. In the illustrative arrangement of FIG. 14, sensor 84 emits and detects signals along the vertical dimension, perpendicular to longitudinal axis 54 of finger device 10.

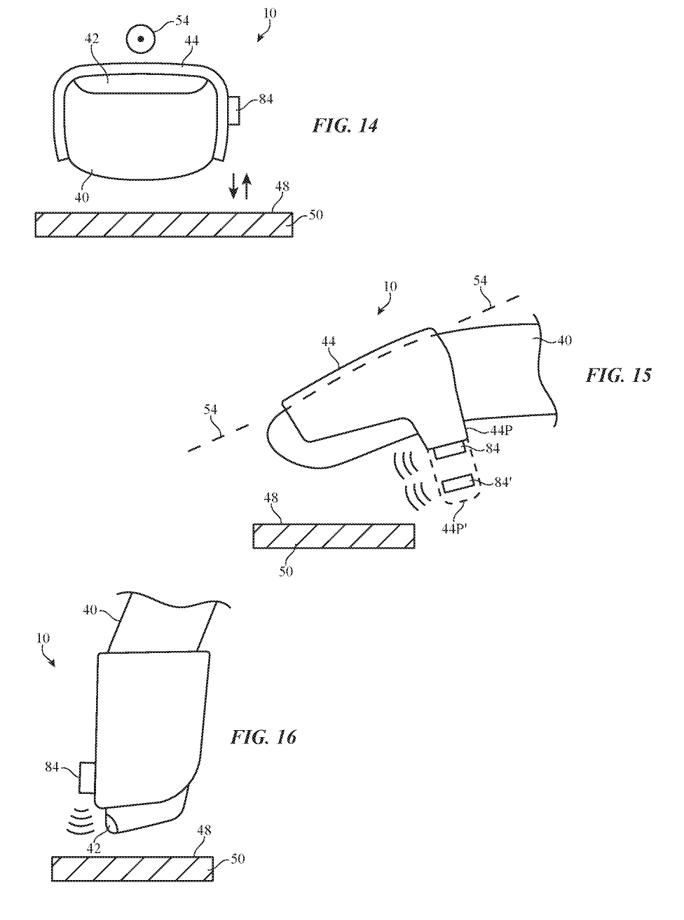

FIG. 15 is a side view of device 10 in an illustrative configuration in which ultrasonic sensor 84 has been mounted on a housing portion (housing portion 44P) that protrudes downwardly from the rest of housing 44. Portion 44P may, if desired, be extended further as shown by elongated portion 44P′ and illustrative ultrasonic sensor 84′. In arrangements such as these, sensor 84 may be directed to emit ultrasonic signals in a forward direction (e.g., along the length of finger 20, parallel to longitudinal axis 54).

In scenarios of the type shown in FIG. 15, sensor 84 (or sensor 84′) can be used to detect when finger 40 is in free space (a scenario in which few emitted ultrasonic signals are reflected back to sensor 84 from the underside of finger 40 and/or surface 48) and to detect when finger 40 is resting against surface 48 (a scenario in which finger 40 and surface 48 form a sound barrier that helps to reflect emitted ultrasonic signals back to sensor 84). In arrangements in which the user moves the front of the tip of finger 40 towards surface 48 (as shown in FIG. 16), sensor 84 can detect the distance of finger 40 (and device 10) from surface 48, can detect whether finger 40 is moving relative to surface 48, etc.

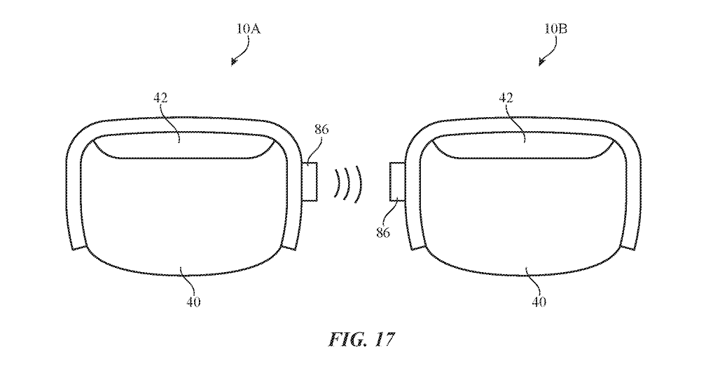

If desired, multiple finger devices 10 may interact in system 8 and may be used in providing multi-finger user input to device 24. Electrical components such as ultrasonic sound emitters and ultrasonic sound detectors can be included in these devices to track relative movements between the devices. Consider, as an example, the arrangement of FIG. 17. In the example of FIG. 17, first finger device 10A and second finger device 10B have ultrasonic devices 86 or other components that track relative movement between devices 10A and 10B. Each device 86 may, for example, have an ultrasonic sound emitter and/or a microphone or other ultrasonic sound detector. During operation, a first of devices 86 may emit ultrasonic signals and a corresponding second of devices 86 may detect ultrasonic signals. If desired, the second device 86 may also transmit signals to the first device. Control circuitry 12 in one or both devices 10 can process the emitted and detected signals to monitor finger motions (e.g., to detect relative motion between device 10A and 10B during a pinch-to-zoom gesture or other multi-finger motion of the user's fingers to supply input). Time-of-flight measurements (e.g., measurements of the amount of time consumed in propagating a signal from device 10A to device 10B), received signal strength measurements (e.g., measurements in which received signal power is used to determine distance), and/or other measurements may be made using devices 86 to determine the locations and/or motions of fingers 40 associated with devices 10A and 10B.

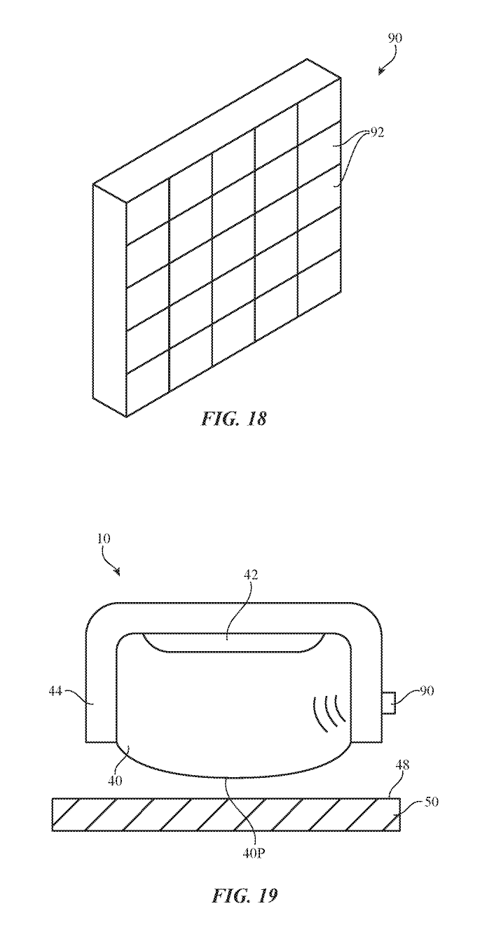

Ultrasonic sensors such as two-dimensional ultrasonic sensor arrays can be used in gathering ultrasonic image data of finger pulp 40P. This ultrasonic image data can be analyzed to determine the shape of finger 40 and thereby analyze whether finger pulp 40P has contacted surface 48 of structure 50. An illustrative two-dimensional ultrasonic image sensor is shown in FIG. 18. As shown in FIG. 18, two-dimensional ultrasonic sensor 90 has a two-dimensional array of ultrasonic sensor elements 92. One or more of elements 92 and/or separate ultrasonic sensor elements can serve as ultrasonic signal emitters (e.g., piezoelectric transducers or other actuators that emit ultrasonic vibrations).

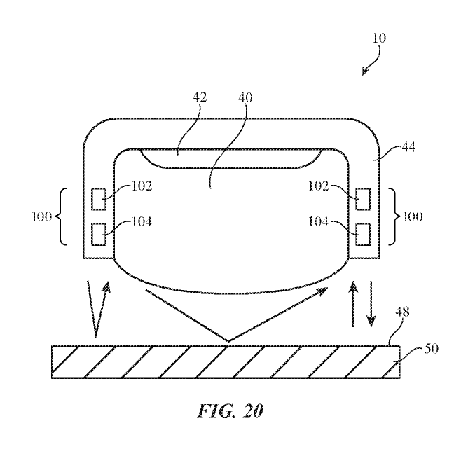

As shown in FIG. 19, sensor 90 may be mounted to housing 44 of device 10 (e.g., on a sidewall portion of housing 44). In this location, sensor 90 may direct ultrasonic signals into finger pulp 40P and can measure reflected ultrasonic signals using the two-dimensional array of elements 92. In this way, control circuitry 12 can gather an ultrasonic image of finger 40, revealing the shape of finger pulp 40P. When finger pulp 40P is not in contact with surface 48, the lower surface of pulp 40P will be rounded. When finger pulp 40P contacts surface 48, the lower surface of pulp 40P will be flattened and device 10 can conclude that finger 40 is touching surface 48. The amount of flattening and location and orientation of any finger pulp deformation can be monitored in real time to determine the location of finger 40, the pressure being applied by finger 40, and/or the orientation of finger 40 (e.g., whether finger 40 is tipped to one side while being pressed against surface 48).

As shown in FIG. 20, optical sensors 100 may be included in devices 10. In the example of FIG. 20, a first optical sensor 100 is mounted on one side of housing 44 and a second optical sensor 100 is mounted on another opposing side of housing 44 (e.g., a housing sidewall on an opposing side of finger 40). Each sensor 100 may have a light emitter 102 and a light detector 104. Light emitters 102 may be light-emitting diodes, lasers, or other light-emitting devices. Light detectors 104 may be phototransistors, photodiodes, or other photodetectors. Sensors 100 may operate at visible wavelengths, infrared wavelengths, and/or other suitable wavelengths.

If desired, a finger device may have a single optical sensor 100. In this arrangement, an optical sensor 100 on one side of finger 40 may emit light and may also detect whether any of the emitted light is reflected from surface 48 and received. The strength of the measured reflected signal may be proportional to the distance between sensor 100 (e.g., device 10 and housing 44) and surface 48 of structure 50. If device 10 is far from surface 48, the reflected signal will be weak. If device 10 is near to surface 48, the reflected signal will be strong.

In configurations in which device 10 contains multiple sensors 100, light emitted from a first of sensors 100 on one side of finger 40 may be measured by a second of sensors 100 on an opposing side of finger 40. When finger 40 is in contact with surface 48, more of the emitted light may be blocked by finger 40 than when finger 40 is not in contact with finger 40. Some light may also be transmitted through pulp 40P, so the amount that finger 40 is compressed against surface 48 may also affect light transmission. As a result, the strength of the emitted light from one sensor 40 that is detected by another sensor 100 may provide information on whether finger 40 is in contact with surface 48, how forcefully finger 40 is pressing against surface 48, and other information about the orientation and motion of finger 40 relative to surface 48.

The optical characteristics of finger 40 (e.g., the outward appearance of finger 40 such as the color of finger 40, the transmittance of finger 40 at one or more different wavelengths of light, etc.) may be monitored using optical sensors 100. As an example, the light emitter 102 on the left of finger 40 may emit light at multiple wavelengths (e.g., one or more infrared wavelengths, one or more visible light wavelengths such as red, green, and blue wavelengths, etc.). The light detector 104 on the right side of finger 40 may be a color light sensor that contains multiple photodetectors that are configured to measure light at different respective wavelengths (e.g., one or more infrared wavelengths, one or more visible light wavelengths such as red, green, and blue wavelengths, or other wavelengths corresponding to the wavelengths of light emitted by emitter 102) and/or light of different colors may be emitted at different times while light detector 104 makes synchronized measurements (e.g., so that the light transmission of finger 40 at each wavelength can be determined). As finger 40 is compressed against surface 48, the color and light transmittance (transmission) of finger 40 will change. The transmission spectrum of finger 40 can be measured dynamically using the multi-wavelength light emitted by light emitter 102 and the color light sensor of detector 104. By analyzing the transmission spectrum (e.g., the color of light transmitted through finger 40), changes in the spectrum (e.g., color changes in finger 40 due to contact with surface 48) can be detected.

If desired, detector 104 may be a color light sensor that monitors the color of finger 40 under exposure to ambient light. Color changes can be detected when finger 40 contacts surface 48 (e.g., finger 40 may appear whiter when compressed against surface 48 so that blood vessels in finger 40 are pinched and contain less blood than when finger 40 is not touching surface 48 and is not compressed). When using ambient light illumination for finger 40, light emitter 102 can be omitted.

Another illustrative configuration measures light transmission through finger 40 at a single wavelength, rather than gathering light transmission data at multiple wavelengths. The amount of light transmission will be affected by finger compression and can therefore be used to detect when finger 40 contacts surface 48. If desired, infrared light, which penetrates into finger 40 more effectively than visible light, may be used (alone or in conjunction with making visible light measurements). For example, an infrared light-emitting diode may be located on the left of finger 40 and a corresponding infrared light detector may be located on the right of finger 40 to monitor infrared light transmission through finger 40.

For measuring the optical characteristics of finger 40, light sensors 100 may be mounted near fingernail 42, where color changes under finger compression are often most evident. For example, one or more light-emitting diodes (visible, infrared, etc.) may emit light into one side of finger 40 near fingernail 42 while detector 104 monitors the amount of this light that is transmitted through finger 40.

Combinations of these arrangements, arrangements in which optical sensing is used to detect occlusion of a light ray traveling under finger 40 as pad 40P touches surface 48, and/or other optical finger sensing arrangements may be used.

In some arrangements, information on devices 10 such as information on finger motion, finger location, finger forces arising from situations in which finger pulp 40 is pressing against external surfaces, and/or other information on the orientation and motion of finger(s) 40 can be gathered using sensing arrangements of more than one type. For example, sensor circuitry for device 10 may include strain gauges, other force sensors, ultrasonic sensors, optical sensors, ultrasonic imaging sensors, ultrasonic sensors measuring finger pulp signal dampening, magnetic sensors, radio-frequency sensors, imaging sensors (e.g., tracking cameras), inertial measurement units (e.g., accelerometers, gyroscopes, and/or compass sensors), touch sensors (e.g., capacitive touch sensors), other sensors, any combination of sensors of one or more, two or more, three or more, or four or more of these sensor types, and/or other finger monitoring arrangements.

During operation of system 8, finger information gathered using one or more finger devices 10 can be used to detect user input. The user input may include user finger gestures including taps, swipes, multi-finger gestures such as pinch-to-zoom gestures, and/or other finger input. In response to finger input gathered with finger devices 10, devices 10 and/or one or more devices that receives the finger information from devices 10 such as electronic device 24 of system 8 of FIG. 1 can take suitable action. As an example, haptic output can be provided to a user with haptic output devices in finger devices 10 and/or devices 24, information may be displayed using a display and/or other light-based output devices (e.g., components in devices 24), sound may be provided using speakers in devices 10 and/or devices 24, and/or other output may be generated. Finger input from device 10 may be used in controlling any suitable software running on system 8 (e.g., mixed reality software, virtual reality software, drawing applications, gaming applications, word processing applications and other productivity applications, operating system functions, etc.).

A perspective view of finger device 10 in an illustrative configuration in which housing 44 of device 10 has a curved trailing edge such as curved rear edge 44E is shown in FIG. 21. The shape of curved rear edge 44E may provide clearance between housing 44E and the user's knuckle to help prevent interference between housing 44 and a user's finger during situations in which the user's finger bends. When viewed from the side, edge 44E may extend diagonally from lower forward portion 44F to upper rear portion 44R of housing 44. Housing 44 may have a shape that conforms to a user's fingertip and that is suitable for gathering sensor measurements. For example, curved arms 52 may have tip portions 52′ that taper towards each other at the forward ends of arms 52. Arms 52 may be formed from flexible material (sheet metal, polymer, elastomeric material, other materials, and/or combinations of these materials) so that arms 52 can deflect under force from the flesh of a user's finger. The tapered tip configuration and flexibility of arms 52 of FIG. 21 may help ensure that fingertip movements are accurately measured by the force sensors or other sensors coupled to curved arms 52.

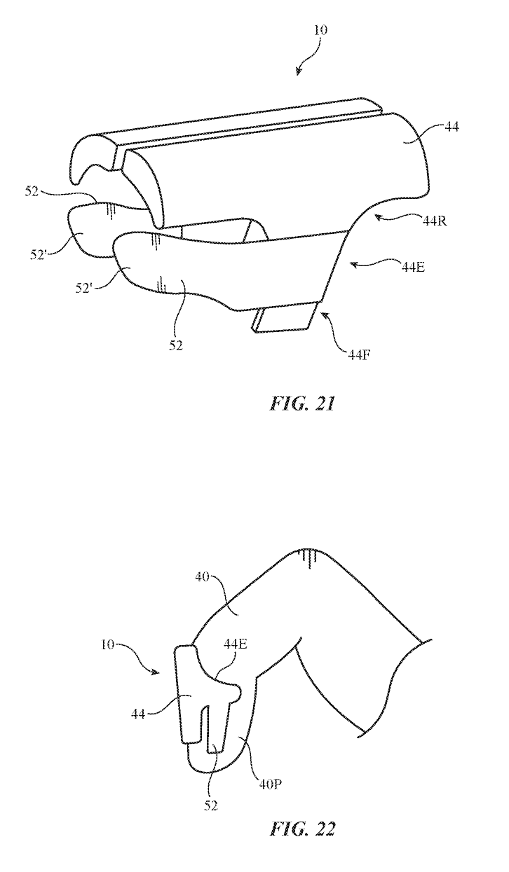

FIG. 22 is a side view of a finger device such as device 10 of FIG. 21. As shown in FIG. 22, the recessed portion of housing 44 that is formed from curved rear housing edge 44E may help prevent undesired interference between finger 40 (e.g., portions of finger 40 near the user's knuckle) as finger 40 is bent (e.g., as a user is touching a surface with finger 40).

The foregoing is merely illustrative and various modifications can be made to the described embodiments. The foregoing embodiments may be implemented individually or in any combination.

What is claimed is:

1. A finger device configured to be worn on a finger of a user, comprising:
a housing configured to be coupled to the finger without covering a lower finger pad surface of the finger;
an ultrasonic sensor coupled to the housing; and
control circuitry configured to gather input from the sensor as the finger moves and configured to provide haptic output to the finger using the haptic output device.

2. The finger device defined in claim 1 wherein the housing has a U shape with first and second opposing sides configured to rest respectively on first and second opposing sides of the finger, wherein the ultrasonic sensor comprises a two-dimensional ultrasonic imaging sensor, wherein the finger device further comprises a haptic output device, and wherein the control circuitry is further configured to supply haptic output to the finger using the haptic output device.

3. The finger device defined in claim 2 wherein the ultrasonic sensor is mounted on the first side.

4. The finger device defined in claim 1 wherein the housing has a U shape with first and second opposing sides configured to rest respectively on first and second opposing sides of the finger.

5. The finger device defined in claim 4 wherein the ultrasonic sensor comprises an ultrasonic signal emitter and an ultrasonic signal detector.

6. The finger device defined in claim 5 wherein the ultrasonic signal emitter is mounted to the first side and wherein the ultrasonic signal detector is mounted to the second side.

7. The finger device defined in claim 4 wherein the housing extends along a longitudinal axis of the finger and wherein the ultrasonic sensor comprises an ultrasonic signal emitter coupled to the first side and configured to emit ultrasonic signals along the longitudinal axis.

8. The finger device defined in claim 4 wherein the housing extends along a longitudinal axis of the finger and wherein the ultrasonic sensor comprises an ultrasonic signal emitter coupled to the first side and configured to emit ultrasonic signals along a direction perpendicular to the longitudinal axis.

9. The finger device defined in claim 4 wherein the first and second sides have respective first and second curved cross-sectional profiles.

10. A finger device configured to be worn on a finger of a user, comprising:
a U-shaped housing having first and second portions configured to rest respectively on first and second opposing sides of the finger without covering a lower finger pad surface of the finger, wherein the first and second portions have respective first and second elongated arms that rest against the finger; and
strain gauge circuitry configured to receive strain measurements as the first and second elongated arms bend.

11. The finger device defined in claim 10 further comprising:
a haptic output device coupled to the U-shaped housing; and
control circuitry configured to gather the strain measurements from the strain gauge circuitry as the finger moves and configured to provide haptic output to the finger using the haptic output device.

12. The finger device defined in claim 11 wherein the first and second elongated arms each have a curved cross-sectional profile.

13. The finger device defined in claim 12 wherein the first and second elongated arms each have a bent tip that wraps partway around a tip of the finger.

14. The finger device defined in claim 13 wherein the U-shaped housing has a longitudinal axis and wherein the first and second elongated arms extend parallel to the longitudinal axis.

15. The finger device defined in claim 14 wherein the U-shaped housing has a first slot adjacent to the first elongated arm and a second slot adjacent to the second elongated arm.

16. The finger device defined in claim 15 wherein the U-shaped housing has third and fourth arms with curved profiles that extend partly under respective left and right sides of the finger.

17. The finger device defined in claim 13 wherein the U-shaped housing has a longitudinal axis and wherein the first and second elongated arms extend perpendicularly to the longitudinal axis.

18. The finger device defined in claim 10 further comprising an elastomeric member coupled to the U-shaped housing that is configured to contact side portions of the finger without contacting the lower finger pad surface of the finger.

19. A finger device configured to be worn on a finger of a user, comprising:
a housing having first and second portions configured to rest respectively on first and second opposing sides of the finger while leaving a finger pad surface of the finger exposed;
a haptic output device coupled to the housing; and
an optical sensor; and
control circuitry configured to provide haptic output to the finger using the haptic output device based on measurements from the optical sensor.

20. The finger device defined in claim 19 wherein the optical sensor is coupled to the first portion and comprises:
a light-emitting device configured to emit light; and
a light-detecting device configured to measure the emitted light, wherein the control circuitry is configured to provide the haptic output based on measurements of the emitted light by the light-detecting device.

21. The finger device defined in claim 19 wherein the optical sensor includes a light emitter and a light detector configured to detect emitted light from the light emitter that has passed through the finger.

22. The finger device defined in claim 21 wherein the light emitter comprises a light-emitting diode.

23. The finger device defined in claim 19 wherein the optical sensor is configured to detect color changes in the finger.
